(19) United States
(12) Patent Application Publication
(10) Pub. No.: US 2006/0195470 A1
(43) Pub. Date: Aug. 31, 2006

(54) Automatic communication in warranty processing

(76) Inventor: Jieqiong Wu, Shanghai (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/066,251

(22) Filed: Feb. 28, 2005

(51) Int. Cl. G06F 17/00

(52) U.S. Cl. 707/103 Y

(57) ABSTRACT

Methods and systems for automated claim processing by a processing system. The processing system receives a claim request in a standard electronic exchange format containing claim data corresponding to the claim request and matches the claim data with at least one record in a data conversion table in order to transform the claim request. Using the data extracted from the claim request, the processing system generates a transformed claim request by mapping organizational codes in the claim request to the organizational codes of a receiving organization. The processing system processes the transformed claim request, generates a claim confirmation, and modifies the claim confirmation by mapping the receiving organization's claim number in the claim confirmation against the data conversion table. Finally, the processing system sends out the modified claim confirmation in a second standard electronic exchange format.

### TECHNICAL FIELD

This invention relates to the field of enterprise software system automation. More particularly, the present invention relates to methods and systems for automatic communication in warranty processing.

### BACKGROUND

Enterprise software systems are integrated software systems that facilitate the flow of information among all the processes of an organization's supply chain. With the ever-increasing popularity of enterprise software systems among companies, firms, and organizations of all sizes, more and more organizations are communicating directly via standard electronic exchange formats. As a result, organizations require efficient and straightforward ways to automatically communicate electronic data with other organizations' enterprise software systems.

Electronic Data Interchange (“EDI”) is used to electronically exchange business documents, such as schedule lines, purchase orders, invoices, and so on. Because of the particularly large volumes of data and very high logistical demands, EDI is now indispensable in logistics for many industries such as the automotive industry. Just-in-time processing and optimized utilities processes for production require fast and reliable data transmission between business partners.

To enable partners to communicate, it is necessary to define the route via which data is exchanged (point-to-point, mailbox, and so on), and the structure and format of the data exchanged. For this purpose, EDI standards have been defined, which specify the structure and format of the individual business documents.

Existing commercially available software may be used as a converter or a translator to facilitate communication between various software systems. For example, an EDI subsystem may be used. However, existing software translates between different electronic communication standards but does not take into account different organizational structures between organizations in which the various software systems reside, thus rendering the converted electronic communication incompatible with the organizational structure of the organization receiving the electronic communication.

### SUMMARY

Consistent with the principles of the present invention, a method is provided for automated processing of data generated by a computer with a data transformation program, the transformation program having a plurality of data tables, at least a first data table having a plurality of records mapping a first organizational structure to a second organizational structure. The method comprises receiving a claim request in a standard electronic exchange format containing claim data corresponding to the claim request, wherein the claim data utilizes the first organizational structure, matching the claim data with at least one record in the first data table such that the record maps the first organizational structure to the second organizational structure, transforming the claim request based on the claim data and the record in the data table such that the transformed claim request corresponds to the second organizational structure, processing the transformed claim request, and generating a claim confirmation based on the processing.

Consistent with another embodiment of the present invention, an apparatus is provided for automated processing of data generated by a computer with a data transformation program, the transformation program having a plurality of data tables, at least a first data table having a plurality of records mapping a first organizational structure to a second organizational structure. The apparatus comprises an input component for receiving a claim request data and a processor including an automated processing module, wherein the automated processing module receives a claim request in a standard electronic exchange format containing claim data corresponding to the claim request and the claim data utilizes the first organizational structure, matches the claim data with at least one record in the first data table such that the record maps the first organizational structure to the second organizational structure, transforms the claim request based on the claim data and the record in the data table such that the transformed claim request corresponds to the second organizational structure, processes the transformed claim request, and generates a claim confirmation based on the processing.

Consistent with another embodiment of the present invention, a computer-readable medium including instructions, executable by a processor, for performing a method for automated processing of data generated by a computer with a data transformation program, the transformation program having a plurality of data tables, at least a first data table having a plurality of records mapping a first organizational structure to a second organizational structure, comprising receiving a claim request in a standard electronic exchange format containing claim data corresponding to the claim request, wherein the claim data utilizes the first organizational structure, matching the claim data with at least one record in the first data table such that the record maps the first organizational structure to the second organizational structure, transforming the claim request based on the claim data and the record in the data table such that the transformed claim request corresponds to the second organizational structure, processing the transformed claim request, and generating a claim confirmation based on the processing.

Both the foregoing general description and the following detailed description are exemplary and explanatory only. They do not restrict the invention, as claimed. Furthermore, the accompanying drawings, which are incorporated in and constitute a part of this specification, illustrate one (or several) embodiments of the invention and together with the description, serve to explain the principles of the invention.

### BRIEF DESCRIPTION OF THE DRAWINGS

FIG. 1 is a block diagram of an exemplary system for allowing an enterprise software system to automatically communicate and process electronic data with enterprise software systems of other organizations and enterprises having different organizational structures; and

FIG. 2 is an exemplary data conversion table for automated processing of electronic data communicated between an enterprise software system and one or more enterprise software systems of other organizations and enterprises having different organizational structures.

FIGS. 3-4 are flow diagrams for alternative embodiments for automated processing of electronic data communicated between an enterprise software system and one or more enterprise software systems of other organizations and enterprises having different organizational structures.

### DETAILED DESCRIPTION

Reference will now be made in detail to the present embodiments of the invention, examples of which are illustrated in the accompanying drawings. Wherever possible, the same reference numbers will be used throughout the drawings to refer to the same or like parts.

Methods and systems consistent with the present invention provide a mechanism for automatic communication between enterprise software systems of different enterprises and organizations having different organizational structures.

In one embodiment, the mechanism receives a claim request in a standard electronic exchange format containing claim data corresponding to the claim request. For example, the claim request may come in EDI format. The mechanism matches the claim data with at least one record in a data conversion table in order to transform the claim request based on the claim data and the data conversion table. For instance, the mechanism extracts from the claim request the client code of the source organization sending the claim request, the type of warranty object, the warranty claim group, and the part number. Using the data extracted from the claim request, the mechanism then generates a transformed claim request by mapping the organizational codes in the claim request to the organizational codes of the receiving organization.

Next, the mechanism processes the transformed claim request, and generates a claim confirmation based on the processing. The mechanism then modifies the claim confirmation by mapping the receiving organization's claim number in the claim confirmation against the data conversion table, resulting in a modified claim confirmation that contains claim number in the source organization's code. The mechanism sends the modified claim confirmation to the source computer in a standard electronic exchange format, such as EDI. Upon receiving the modified claim confirmation, the source computer updates the claim request based on the modified claim confirmation.

System Configuration

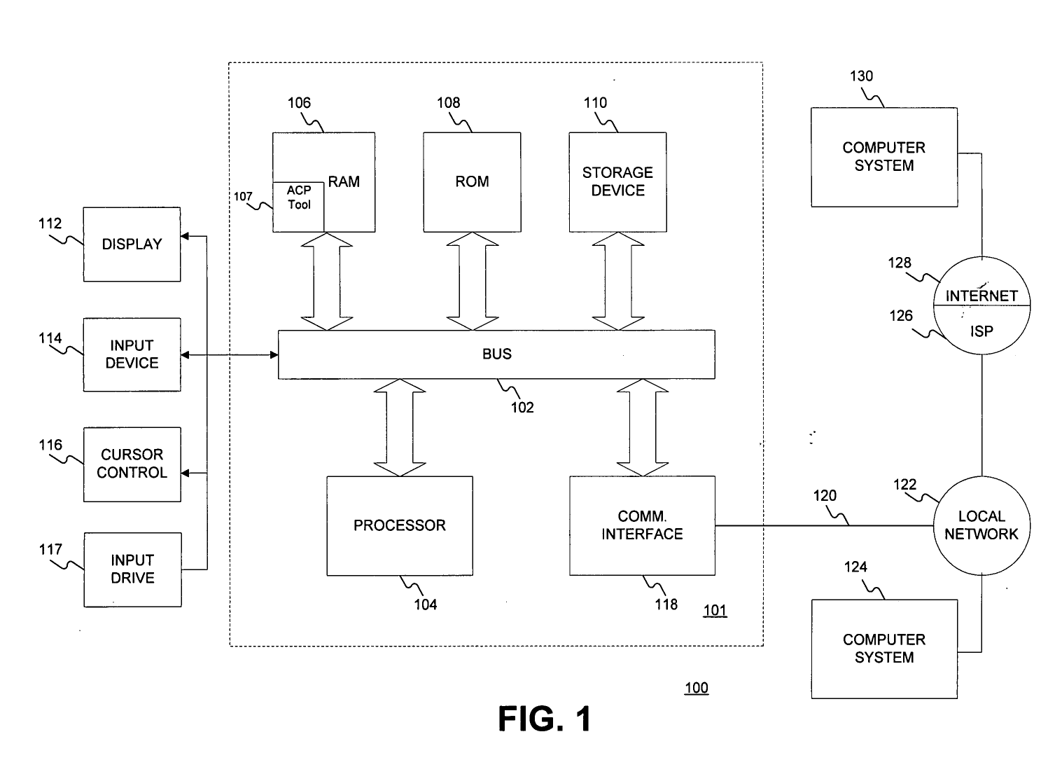

Systems and methods consistent with the present invention may be implemented by computers organized in a conventional distributed processing system architecture. FIG. 1 is a block diagram illustrating a computer system 100 in which an embodiment consistent with the invention may be implemented. Computer system 100 includes a computer 101 having a bus 102 or other communication mechanism for communicating information, and a processor 104 coupled with bus 102 for processing information. Computer 101 also includes a main memory, such as random access memory (RAM) 106 or other dynamic storage device, coupled to bus 102 for storing information and instructions to be executed by processor 104. RAM 106 also may be used for storing temporary variables or other intermediate information during execution of instructions to be executed by processor 104. Computer 101 may further include a read only memory (ROM) 108 or other static storage device coupled to bus 102 for storing static information and instructions for processor 104. A storage device 110, such as a magnetic disk or optical disk, may be provided and coupled to bus 102 for storing information and instructions.

Computer 101 may be coupled via bus 102 to a display 112, such as a cathode ray tube (CRT), for displaying information to a computer user. An input device 114, such as a keyboard including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (e.g., x) and a second axis (e.g., y), which allow the device to specify positions in a plane. System 100 may further include an input drive device 117, such as a CD reader, for reading high-capacity computer-readable media, such as CD-ROMs and CDRs.

According to one implementation, systems and methods consistent with the present invention automatically process data sent to or received from a first computer system 130 when processor 104 executes one or more sequences of instructions, such as an automated claim processing tool 107, contained in RAM 106. Such instructions may be read into RAM 106 from a computer-readable medium via an input device such as storage device 110. Execution of the sequences of instructions contained in main memory 106 causes processor 104 to perform the process steps described herein. In an alternative implementation, hard-wired circuitry may be used in place of or in combination with software instructions to implement the invention. Thus, implementations consistent with the principles of the present invention are not limited to any specific combination of hardware circuitry and software.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications. Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, a carrier wave as described hereinafter, or any other medium from which a computer can read.

Various forms of computer-readable media may be involved in carrying one or more sequences of instructions to processor 104 for execution. For example, the instructions may initially be carried on the magnetic disk of a remote computer. The remote computer can load the instructions into its dynamic memory and send the instructions over a telephone line using a modem. A modem (not shown) local to computer system 100 can receive the data on the telephone line and supply the data to computer 101 via a communications interface 118, which places the data on bus 102. Bus 102 carries the data to main memory 106, from which processor 104 retrieves and executes the instructions. The instructions received by main memory 106 may optionally be stored on storage device 110 either before or after execution by processor 104.

Communication interface 118 may also provide a two-way data communication coupling to a network link 120 that may be connected to a local network 122. For example, communication interface 118 may support an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a second computer system 124 and/or to data equipment operated by an Internet Service Provider (ISP) 126. ISP 126, in turn, provides data communication services through the Internet 128. Local network 122 and Internet 128 both use electric, electromagnetic, or optical signals to carry digital data streams. The signals through the various networks and the signals on network link 120 and through communication interface 118, which carry the digital data to and from computer system 100, are exemplary forms of carrier waves transporting the information.

Computer system 100 can send and receive data, including program code, through the network(s), network link 120, and communication interface 118. In the Internet example, a first computer system 130 might transmit requested program instructions for an application program through Internet 128, ISP 126, local network 122, and communication interface 118. Consistent with the present invention, one such downloaded application in the form of a automated claim processing tool 107 comprises an automated processing module which processes the claim request from a source computer in a source organization having different organizational structures. The automated processing module, which may contain executable scripts, program codes, stored procedures, database triggers, or a combination thereof, operates as the automated claim processing tool 107. The received application code may be loaded in RAM 106 and executed by processor 104 as it is received. Alternatively, or in addition, it may be stored in storage device 110, or other non-volatile storage for later execution. In this manner, computer system 100 may obtain application code in the form of a carrier wave.

Although computer system 100 is shown in FIG. 1 as being connectable to the first computer system 130, those skilled in the art will recognize that computer system 100 may establish connections to multiple servers on Internet 128. Such servers may include an HTML-based Internet application, which may provide information to computer system 100 upon request in a manner consistent with the present invention.

Data Conversion Table for Automated Claim Processing

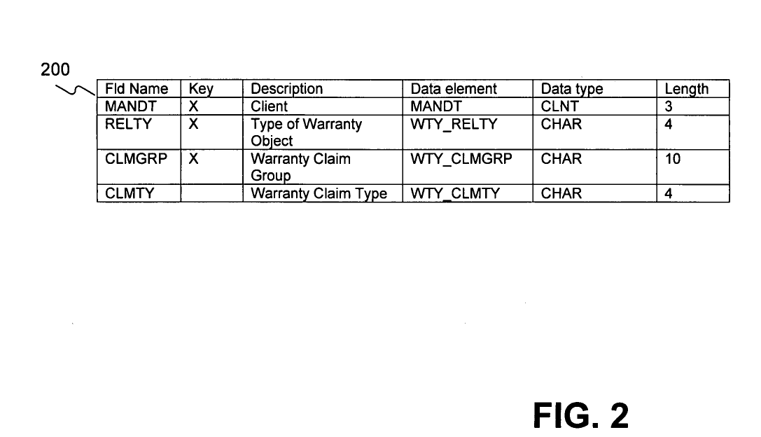

FIG. 2 is an exemplary data conversion table for automated processing of electronic data communicated between an enterprise software system and one or more enterprise software systems of other organizations and enterprises having different organizational structures. The exemplary data conversion table 200 may be used, for example, to automatically process warranty claims communicated between a source computer residing in a source organization and a target computer residing in a target organization.

The exemplary data conversion table 200 maps the organization structure of the target organization to the organization structure of the source organization, and may be stored in either the source computer or the target computer. For instance, the automated claim processing tool (e.g. FIG. 1, element 107) may retrieve the target organization's warranty claim type code from data conversion table 200 by keying in the client code, type of warranty object, and warranty claim group. In one embodiment in which the data conversion table 200 is stored in the source computer in the source organization, the exemplary client code is the organization identification code for the target organization. In an alternative embodiment in which the data conversion table 200 resides in the target computer in the target organization, the exemplary client code is the organization code for the source organization. Moreover, the exemplary client code may be used to map other organizational codes between the target and the source organizations, such as part numbers or claim numbers. One of ordinary skill in the art will recognize that implementations of the data conversion table, consistent with the principles of the present invention, are not limited to any specific format or content.

System Operation for Automated Claim Processing

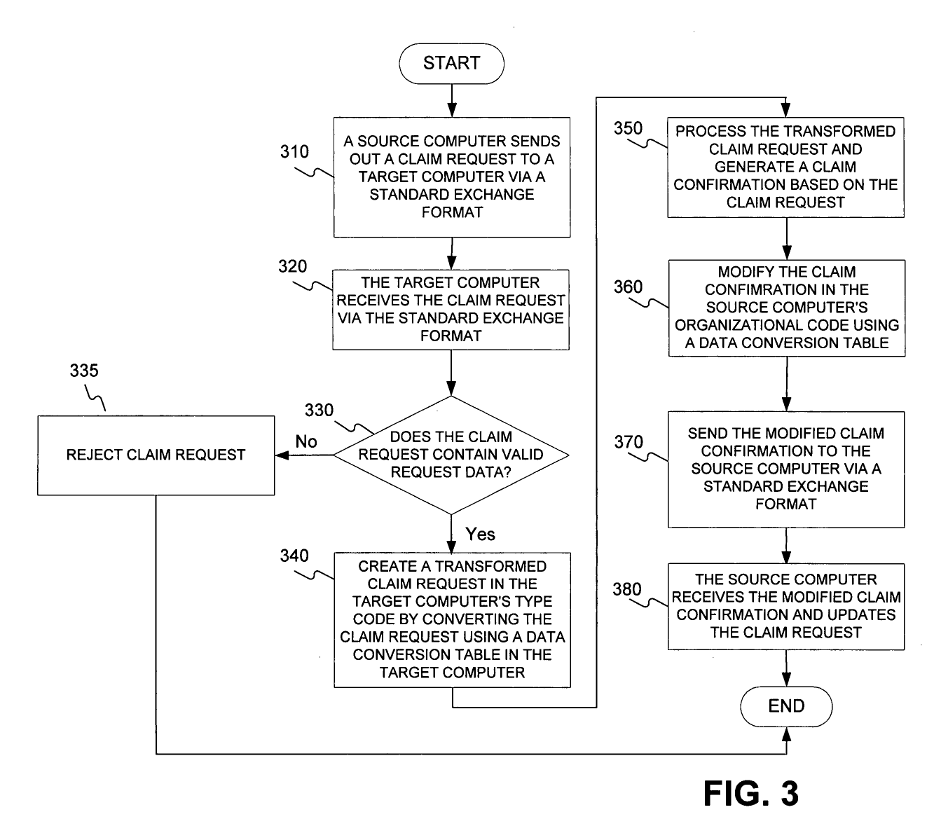

FIG. 3 is a flow diagram of a process for automated processing of electronic data communicated between an enterprise software system and one or more enterprise software systems of other organizations and enterprises having different organizational structure. The process may be used, for example, to automatically process warranty claims communicated between a source computer (e.g. FIG. 1, element 124 or 130) residing in a source organization and a target computer (e.g. FIG. 1, element 101) residing in a target organization.

At the start of the process as indicated in stage 310, the source computer sends a claim request to the target computer in a standard electronic exchange format, such as EDI. Upon receiving the claim request in stage 320, the target computer's processor (e.g. FIG. 1, element 106) executes instructions for automated claim processing (e.g. FIG. 1 element 107) and verifies that the claim request contains valid request data in stage 330. The execution of the instructions for automated claim processing may occur automatically, for example, by means of executable scripts, program codes, stored procedures, database triggers, or a combination thereof, when the target computer system receives the claim request via a network (e.g. FIG. 1 elements 122, 126, and 128) from a source computer. The computer system may also execute instructions for automated claim processing through a manual process, for example, when a user manually initiates the execution of the instructions for automated claim processing. If the claim request fails verification in stage 330, the process proceeds to stage 335, and the target computer rejects the claim request and terminates the process. Alternatively, if the claim request satisfies verification in stage 330, the process proceeds to stage 340.

In stage 340, the target computer transforms the claim request using a data conversion table (e.g. FIG. 2 element 200) in the automated claim processing tool (e.g. FIG. 1 element 107). For example, the claim request from the source computer may contain the source organization's client code, the type of warranty object, and the warranty claim group. The process in stage 340 transforms the claim request from the source computer by mapping the data in the claim request against the data conversion table, resulting in a transformed claim request that contains claim information in the target organization's code such that the transformed claim request may be directly processed by the target computer. Next, in stage 350, the transformed claim request is processed and a claim confirmation is generated based on the transformed claim request.

In stage 360, the target computer modifies the claim confirmation by mapping the target organization's claim number in the claim confirmation against the data conversion table, resulting in a modified claim confirmation that contains claim number in the source organization's code such that the modified claim confirmation may be directly processed by the source computer. Then, in stage 370, the target computer sends the modified claim confirmation to the source computer in a standard electronic exchange format, such as EDI. Upon receiving the modified claim confirmation in stage 380, the source computer updates the claim request based on the modified claim confirmation.

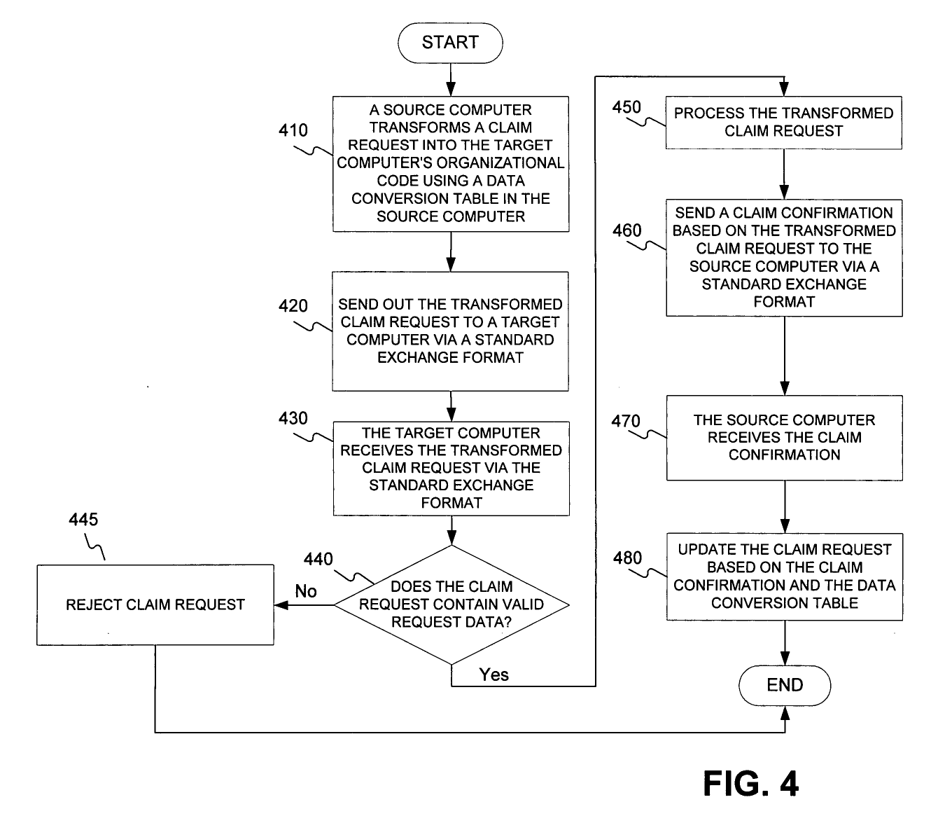

FIG. 4 is a flow diagram of an alternative process for automated processing of electronic data communicated between an enterprise software system and one or more enterprise software systems of other organizations and enterprises having different organizational structure. This process may be used, for example, to automatically process warranty claims communicated between a source computer (e.g. FIG. 1, element 101) residing in a source organization and a target computer (e.g. FIG. 1, element 124 or 130) residing in a target organization.

At the start of the process as indicated in stage 410, the source computer prepares a claim request by executing the automated processing tool (e.g. FIG. 1, element 107). The execution of the instructions for automated claim processing may occur automatically, for example, by means of executable scripts, program codes, stored procedures, database triggers, or a combination thereof, when the source computer system generates a claim request. The computer system may also execute instructions for automated claim processing through a manual process, for example, when a user manually initiates the execution of the instructions for automated claim processing.

Using the automated processing tool, the source computer transforms the claim request using a data conversion table (e.g. FIG. 2 element 200) in the automated claim processing tool. For example, the claim request from the source computer may contain the target organization's client code, the type of warranty object, and the warranty claim group. The process in stage 410 transforms the claim request from the source computer by mapping the data in the claim request against the data conversion table, resulting in a transformed claim request that contains claim information in the target organization's code such that the transformed claim request may be directly processed by the target computer. Next, in stage 420, the source computer sends the transformed claim request to the target computer in a standard electronic exchange format, such as EDI. In stage 430, the target computer receives the claim request, for example, via a network (e.g. FIG. 1 elements 122,126, and 128), from the source computer.

Upon receiving the transformed claim request in stage 430, the target computer verifies that the claim request contains valid request data in stage 440. If the claim request fails verification in stage 440, the process proceeds to stage 445, and the target computer rejects the claim request and terminates the process. Alternatively, if the claim request satisfies verification in stage 440, the process proceeds to stage 450. In stage 450, the transformed claim request is processed and a claim confirmation is generated based on the transformed claim request.

Next, in stage 460, the target computer sends the claim confirmation to the source computer in a standard electronic exchange format, such as EDI. Upon receiving the claim confirmation in stage 470, the source computer in stage 480 updates the claim request based on the claim confirmation and the data conversion table by mapping the target organization's claim number in the claim confirmation against the data conversion table, resulting in a modified claim confirmation that contains claim number in the source organization's code such that the modified claim confirmation may be directly processed by the source computer.

The foregoing descriptions of the invention have been presented for purposes of illustration and description. They are not exhaustive and do not limit the invention to the precise form disclosed. Modifications and variations are possible in light of the above teachings or may be acquired from practicing of the invention. For example, the described implementation includes software but the present invention may be implemented as a combination of hardware and software or in hardware alone. Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM. The scope of the invention is defined by the claims and their equivalents.

Other embodiments of the invention will be apparent to those skilled in the art from consideration of the specification and practice of the invention disclosed herein. The specification and examples should be considered as exemplary only, with a true scope and spirit of the invention being indicated by the following claims.

What is claimed is:

1. A method for automated processing of data generated by a computer with a data transformation program, the transformation program having a plurality of data tables, at least a first data table having a plurality of records mapping a first organizational structure to a second organizational structure, comprising:
receiving a claim request in a standard electronic exchange format containing claim data corresponding to the claim request, wherein the claim data utilizes the first organizational structure;
matching the claim data with at least one record in the first data table such that the record maps the first organizational structure to the second organizational structure;
transforming the claim request based on the claim data and the record in the data table such that the transformed claim request corresponds to the second organizational structure;
processing the transformed claim request; and
generating a claim confirmation based on the processing.

2. The method of claim 1, further comprising:
modifying the claim confirmation based on the data tables such that the modified claim confirmation corresponds to the first organizational structure; and
sending the updated claim confirmation in a second standard electronic exchange format.

3. The method of claim 1, further comprising:
sending the claim confirmation in a second standard electronic exchange format; and
updating the claim request based on the claim confirmation and the data tables.

4. A method for automated processing of data generated by a computer with a data transformation program, the transformation program having a plurality of data tables, at least a first data table having a plurality of records mapping a first organizational structure to a second organizational structure, comprising:
creating a claim request containing claim data corresponding to the claim request, wherein the claim data utilizes the first organizational structure;
matching the claim data with at least one record in the first data table such that the record maps the first organizational structure to the second organizational structure;
transforming the claim request based on the claim data and the record in the first data table such that the transformed claim request corresponds to the second organizational structure;
sending the transformed claim request in a standard electronic exchange format; and
receiving a claim confirmation for the transformed claim request in a second standard electronic exchange format.

5. The method of claim 4, further comprising:
modifying the claim confirmation based on the data tables such that the modified claim confirmation corresponds to the first organizational structure; and
updating the claim request based on the modified claim confirmation.

6. The method of claim 4, further comprising:
updating the claim request based on the claim confirmation and the data tables.

7. An apparatus for automated processing of data generated by a computer with a data transformation program, the transformation program having a plurality of data tables, at least a first data table having a plurality of records mapping a first organizational structure to a second organizational structure, comprising:
an input component for receiving a claim request data; and
a processor including an automated processing module, wherein the automated processing module receives a claim request in a standard electronic exchange format containing claim data corresponding to the claim request and the claim data utilizes the first organizational structure, matches the claim data with at least one record in the first data table such that the record maps the first organizational structure to the second organizational structure, transforms the claim request based on the claim data and the record in the data table such that the transformed claim request corresponds to the second organizational structure, processes the transformed claim request; and generates a claim confirmation based on the processing.

8. The apparatus of claim 7, wherein the automated processing module further modifies the claim confirmation based on the data tables such that the modified claim confirmation corresponds to the first organizational structure and sends the updated claim confirmation in a second standard electronic exchange format.

9. The apparatus of claim 7, wherein the automated processing module further sends the claim confirmation in a second standard electronic exchange format and updates the claim request based on the claim confirmation and the data tables.

10. A computer-readable medium including instructions, executable by a processor, for performing a method for automated processing of data generated by a computer with a data transformation program, the transformation program having a plurality of data tables, at least a first data table having a plurality of records mapping a first organizational structure to a second organizational structure, comprising:
receiving a claim request in a standard electronic exchange format containing claim data corresponding to the claim request, wherein the claim data utilizes the first organizational structure;
matching the claim data with at least one record in the first data table such that the record maps the first organizational structure to the second organizational structure;
transforming the claim request based on the claim data and the record in the data table such that the transformed claim request corresponds to the second organizational structure;
processing the transformed claim request; and
generating a claim confirmation based on the processing.

11. The computer-readable medium of claim 10, wherein generating further comprises:
modifying the claim confirmation based on the data tables such that the modified claim confirmation corresponds to the first organizational structure; and
sending the updated claim confirmation in a second standard electronic exchange format.

12. The computer-readable medium of claim 10, wherein generating further comprises:
sending the claim confirmation in a second standard electronic exchange format; and
updating the claim request based on the claim confirmation and the data tables.
